(19) United States
(12) Patent Application Publication
(10) Pub. No.: US 2006/0037706 A1
(43) Pub. Date: Feb. 23, 2006

(54) Beverage bottle labeling apparatus configured to label beverage bottles in a beverage bottling plant

(76) Inventor: Frank Putzer, Hamburg (DE)

Correspondence Address: NILS H. LJUNGMAN;NILS H. LJUNGMAN & ASSOCIATES, P.O. BOX 130, GREENSBURG, PA, 15601-0130, US

(21) Appl. No.: 11/208,407

(22) Filed: Aug. 19, 2005

(30) Foreign Application Priority Data
Aug. 21, 2004 (DE) 10 2004 040 634.0

(51) Int. Cl. B65C 9/40; B65C 9/00; B65C 9/42

(52) U.S. Cl. 156/360; 156/378; 156/567

(57) ABSTRACT

A beverage bottle labeling apparatus configured to label beverage bottles in a beverage bottling plant. The abstract of the disclosure is submitted herewith as required by 37 C.F.R. §1.72(b). As stated in 37 C.F.R. §1.72(b): A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims. Therefore, any statements made relating to the abstract are not intended to limit the claims in any manner and should not be interpreted as limiting the claims in any manner.

### BACKGROUND

1. Technical Field

This invention relates to a beverage bottle labeling apparatus configured to label beverage bottles in a beverage bottling plant as described herein below.

2. Background Information

A beverage bottling plant for filling bottles with a liquid beverage filling material can comprise a beverage filling machine with a plurality of beverage filling positions, each beverage filling position having a beverage filling device for filling bottles with liquid beverage filling material. The filling devices may have an apparatus designed to introduce a predetermined volume of liquid beverage filling material into the interior of bottles to a substantially predetermined level of liquid beverage filling material. The apparatus designed to introduce a predetermined flow of liquid beverage filling material further comprises an apparatus that is designed to terminate the filling of the beverage bottles upon the liquid beverage filling material reaching the predetermined level in bottles. There may also be provided a conveyer arrangement that is designed to move bottles, for example, from an inspecting machine to the filling machine. Upon filling, a closing station closes the filled bottles. There may further be provided a conveyer arrangement configured to transfer filled bottles from the filling machine to the closing station. Bottles may be labeled in a labeling station, the labeling station having a conveyer arrangement to receive bottles and to output bottles. The closing station and the labeling station may be connected by a corresponding conveyer arrangement.

Containers and contoured containers, such as bottles and cans etc., for example, that are used for packaging a wide variety of products, for example for the packaging of beverages or other liquids, bulk goods etc., have dimensional variations that result from the tolerances of the manufacturing methods used, which variations can be up to ±2 mm in the diameter, for example, and up to ±1 mm in height, for example, depending on the type of container, but also on the respective measurement point or measurement location at which said dimensional tolerances are determined.

When containers of this type are labeled, said dimensional variations or tolerances can result in the respective label not being in the desired position on the container in question, and in particular when labels are to be applied in different areas of a container, for example on the neck, shoulder or body of a bottle, said labels may not be oriented in the desired relationship with one another, i.e. the vertical axis of symmetry or center axis of the neck, shoulder and body labels no longer lies on the desired line, or the distances between the side edges of a shoulder label and a body label are no longer equal. Variations in the position of the labels caused by variations in the dimensions of the respective container can thus have an adverse effect on the appearance or the visual attractiveness of the respective labeled container, to the point where the high quality requirements of a bottling plant or of the retail consumer are no longer met.

### OBJECT OR OBJECTS

The object of the invention is to indicate a method which makes it possible, even when there are tolerances or variations in the dimensions of the contour of the container or of the container itself, to position one or more labels in the correct position on a given container, and thus to ensure an attractive visual appearance of the individual labeled container in question.

### SUMMARY

The invention teaches a method for labeling bottles or similar contoured containers with at least one label, in which method the containers are located on container carriers of a conveyor line and are moved past at least one labeling unit, and thereby at least one label is transferred with one side of the label on the outside surface of the respective container and then fixed in position, starting from said side of the label, on the outside surface of the container, characterized by the fact that by means of at least one first sensor unit on the conveyor line, the contour of the respective container and/or the dimensions of said contour that are critical for the labeling and/or the position of any labels that have previously been applied to the container are detected to define the measured values, and that taking into consideration the variance of the measured values from a specified value, the process of applying the respective label to the container to be labeled is controlled so that the respective label is in the desired position after it has been applied to the container.

The invention further teaches a labeling machine for labeling bottles or similar contoured containers with at least one label, in which labeling machine the containers are located on container carriers of a conveyor line and are moved past at least one labeling unit, and thereby at least one label is transferred with one side of the label on the outside surface of the respective container and then fixed in position, starting from said side of the label, on the outside surface of the container, characterized by the fact that by means of a control device with at least one first sensor unit on the conveyor line, the contour of the respective container and/or the dimensions of said contour that are critical for the labeling and/or the position of any labels that have previously been applied to the container are detected to define the measured values, and that taking into consideration the variance of the measured values from a specified value, the process of applying the respective label to the container to be labeled is controlled so that the respective label is in the desired position after it has been applied to the container.

The above-discussed embodiments of the present invention will be described further hereinbelow. When the word “invention” or “embodiment of the invention” is used in this specification, the word “invention” or “embodiment of the invention” includes “inventions” or “embodiments of the invention”, that is the plural of “invention” or “embodiment of the invention”. By stating “invention” or “embodiment of the invention”, the Applicant does not in any way admit that the present application does not include more than one patentably and non-obviously distinct invention, and maintains that this application may include more than one patentably and non-obviously distinct invention. The Applicant hereby asserts that the disclosure of this application may include more than one invention, and, in the event that there is more than one invention, that these inventions may be patentable and non-obvious one with respect to the other.

### BRIEF DESCRIPTION OF THE DRAWINGS

The invention is explained in greater detail below with reference to one exemplary embodiment which is illustrated in the accompanying figures, in which:

FIG. 1A is a schematic illustration of a container filling plant in accordance with one possible embodiment;

FIG. 1 is a simplified schematic illustration showing an overhead view of a labeling machine for labeling bottles or similar contoured containers;

FIG. 1B is similar to FIG. 1 and shows further details according to one possible embodiment;

FIG. 2 is a simplified illustration showing a side view of a bottle on a turntable of the labeling machine illustrated in FIG. 1, in which the turntable acts as a container carrier or bottle carrier;

FIG. 2A is similar to FIG. 2 and shows further detail according to one possible embodiment;

FIG. 3 is a schematic illustration of a shoulder and body label showing their relationship to each other, to explain the invention and the control of the labeling machine illustrated in FIG. 1 as taught by the invention;

FIG. 4 is a schematic partial illustration of different bottle diameters to explain the invention.

### DESCRIPTION OF EMBODIMENT OR EMBODIMENTS

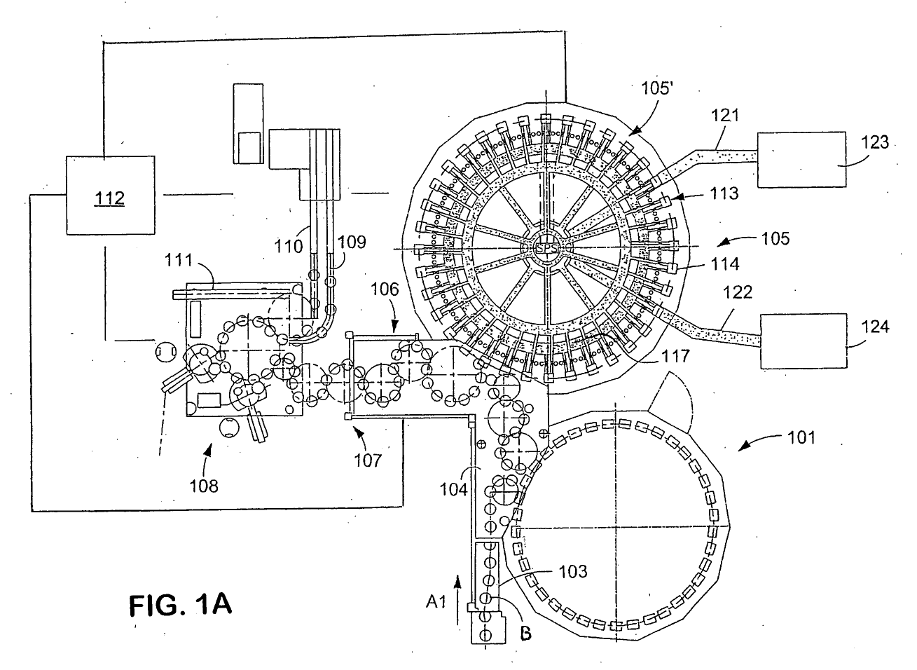

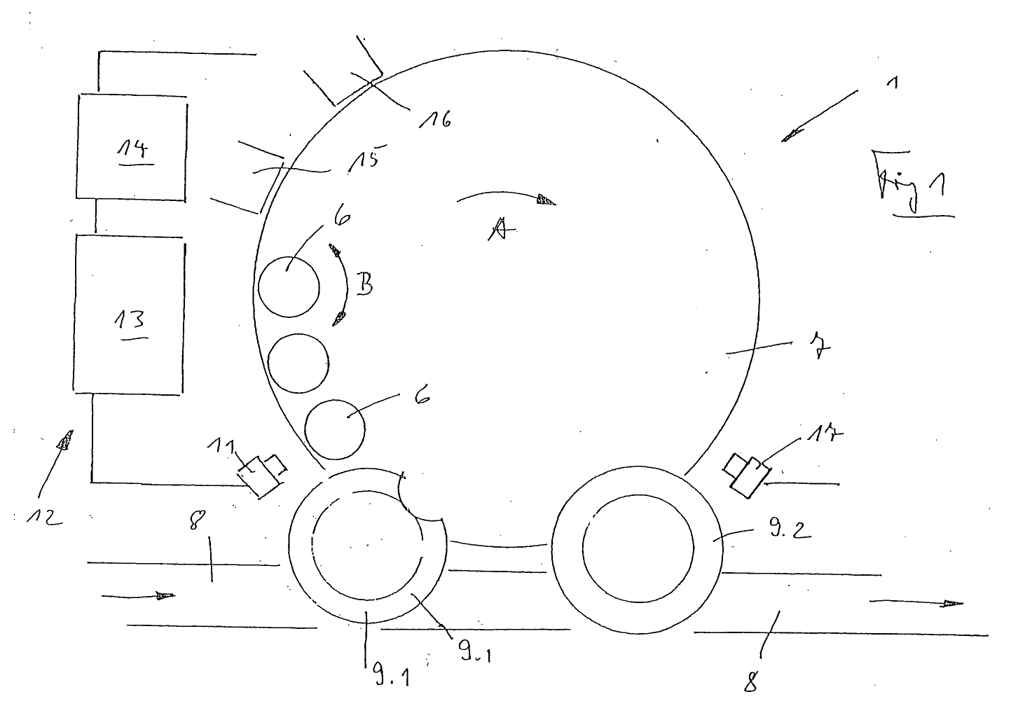

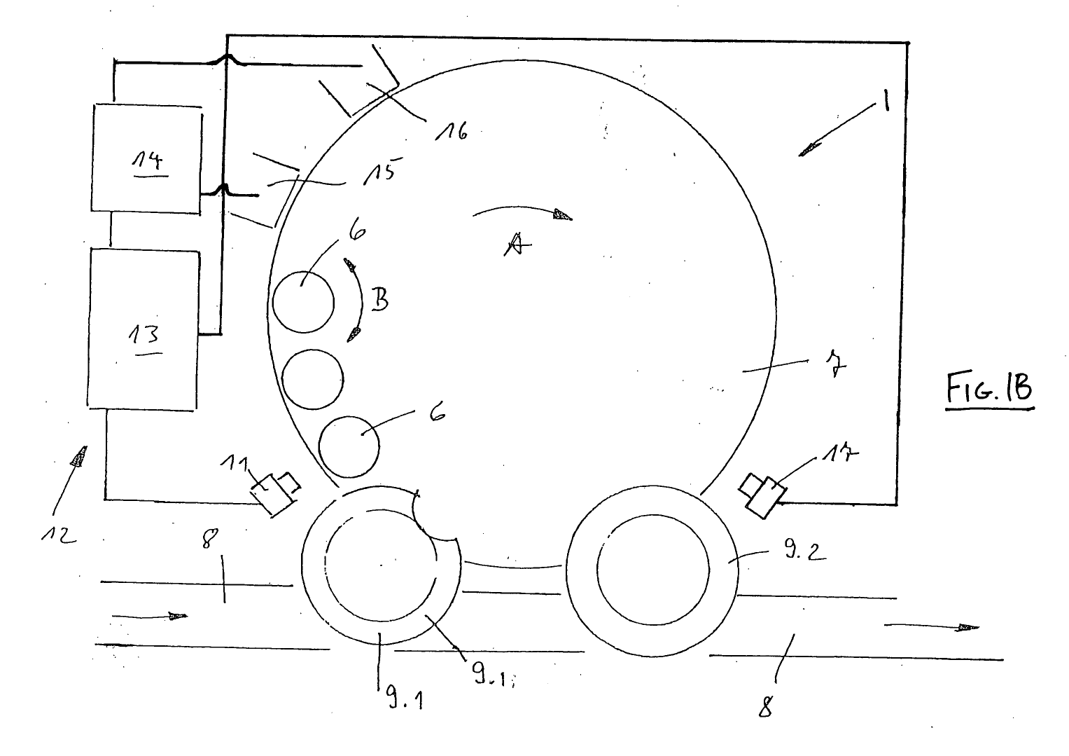

FIG. 1A shows schematically the main components of one possible embodiment example of a system for filling containers, specifically, a beverage bottling plant for filling bottles B with at least one liquid beverage, in accordance with at least one possible embodiment, in which system or plant could possibly be utilized at least one aspect, or several aspects, of the embodiments disclosed herein.

FIG. 1A shows a rinsing arrangement or rinsing station 101, to which the containers, namely bottles B, are fed in the direction of travel as indicated by the arrow A1, by a first conveyer arrangement 103, which can be a linear conveyor or a combination of a linear conveyor and a starwheel. Downstream of the rinsing arrangement or rinsing station 101, in the direction of travel as indicated by the arrow A1, the rinsed bottles B are transported to a beverage filling machine 105 by a second conveyer arrangement 104 that is formed, for example, by one or more starwheels that introduce bottles B into the beverage filling machine 105.

The beverage filling machine 105 shown is of a revolving or rotary design, with a rotor 105′, which revolves around a central, vertical machine axis. The rotor 105′ is designed to receive and hold the bottles B for filling at a plurality of filling positions 113 located about the periphery of the rotor 105′. At each of the filling positions 103 is located a filling arrangement 114 having at least one filling device, element, apparatus, or valve. The filling arrangements 114 are designed to introduce a predetermined volume or amount of liquid beverage into the interior of the bottles B to a predetermined or desired level.

The filling arrangements 114 receive the liquid beverage material from a toroidal or annular vessel 117, in which a supply of liquid beverage material is stored under pressure by a gas. The toroidal vessel 117 is a component, for example, of the revolving rotor 105′. The toroidal vessel 117 can be connected by means of a rotary coupling or a coupling that permits rotation. The toroidal vessel 117 is also connected to at least one external reservoir or supply of liquid beverage material by a conduit or supply line. In the embodiment shown in FIG. 1A, there are two external supply reservoirs 123 and 124, each of which is configured to store either the same liquid beverage product or different products. These reservoirs 123, 124 are connected to the toroidal or annular vessel 117 by corresponding supply lines, conduits, or arrangements 121 and 122. The external supply reservoirs 123, 124 could be in the form of simple storage tanks, or in the form of liquid beverage product mixers, in at least one possible embodiment.

As well as the more typical filling machines having one toroidal vessel, it is possible that in at least one possible embodiment there could be a second toroidal or annular vessel which contains a second product. In this case, each filling arrangement 114 could be connected by separate connections to each of the two toroidal vessels and have two individually-controllable fluid or control valves, so that in each bottle B, the first product or the second product can be filled by means of an appropriate control of the filling product or fluid valves.

Downstream of the beverage filling machine 105, in the direction of travel of the bottles B, there can be a beverage bottle closing arrangement or closing station 106 which closes or caps the bottles B. The beverage bottle closing arrangement or closing station 106 can be connected by a third conveyer arrangement 107 to a beverage bottle labeling arrangement or labeling station 108. The third conveyor arrangement may be formed, for example, by a plurality of starwheels, or may also include a linear conveyor device.

In the illustrated embodiment, the beverage bottle labeling arrangement or labeling station 108 has at least one labeling unit, device, or module, for applying labels to bottles B. In the embodiment shown, the labeling arrangement 108 has three output conveyer arrangement: a first output conveyer arrangement 109, a second output conveyer arrangement 110, and a third output conveyer arrangement 111, all of which convey filled, closed, and labeled bottles B to different locations.

The first output conveyer arrangement 109, in the embodiment shown, is designed to convey bottles B that are filled with a first type of liquid beverage supplied by, for example, the supply reservoir 123. The second output conveyer arrangement 110, in the embodiment shown, is designed to convey bottles B that are filled with a second type of liquid beverage supplied by, for example, the supply reservoir 124. The third output conveyer arrangement 111, in the embodiment shown, is designed to convey incorrectly labeled bottles B. To further explain, the labeling arrangement 108 can comprise at least one beverage bottle inspection or monitoring device that inspects or monitors the location of labels on the bottles B to determine if the labels have been correctly placed or aligned on the bottles B. The third output conveyer arrangement 111 removes any bottles B which have been incorrectly labeled as determined by the inspecting device.

The beverage bottling plant can be controlled by a central control arrangement 112, which could be, for example, computerized control system that monitors and controls the operation of the various stations and mechanisms of the beverage bottling plant.

The labeling machine, which in the figures is designated 1 in general, is used to label bottles 2 that are filled with a liquid and are capped on their bottle mouth with a cap 3, and are each provided with labels 4 and 5, of which the label 4 is a shoulder label and the label 5 is a body label. For this purpose, the label 4 is applied to the shoulder area 2.2 that is adjacent to the neck 2.1 of the bottle and becomes wider toward the bottom of the bottle, and the label 5 is applied to the body area 2.3 of the bottle 2, which in the illustrated embodiment is slightly cinched in and is rotationally symmetrical to its axis.

The bottles 2, because of the manufacturing methods by which they are produced, have certain dimensional variations which, depending on the type of container or bottle 2, and on the point at which they are measured, can be up to ±2.5 mm for the diameter and up to ±1 mm for the height.

The objective, after the labeling of each bottle 2, is for the labels 4 and 5 to be in a defined relationship to the contour of the bottle 2 and also in a defined relationship to each other.

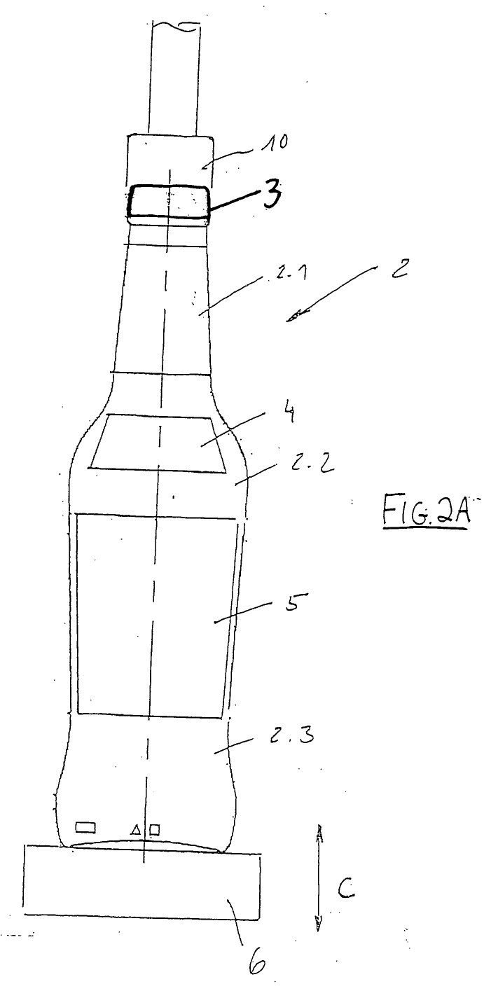

The manufacturing tolerances of the bottles 2 with reference to the bottle diameter and/or the bottle height can cause the labels 4 and 5 to be applied incorrectly in relation to the contour of the bottle 2 and/or in an incorrect relationship relative to each other. A situation of this type is illustrated schematically and by way of example in FIG. 3 by the offset of the axis of symmetry or center axis M4 of the label 4 and the axis of symmetry or center axis M5 of the label 5 in the circumferential direction of the bottle, and in FIG. 3 by the offset of the labels 4 and 5 in the direction of the axis of the bottle indicated by the broken lines 4.1 and 5.1.

By means of an appropriate control system, which is described in greater detail below, of the labeling machine 1 or of the bottle carrier or container carrier 6 on the periphery of a turntable or rotor 7 which is driven so that it rotates around a vertical machine axis, this incorrect position of the labels 4 and 5, which is caused by the dimensional variations of the bottles 2 and adversely affects the visual appearance of the labeled bottles 2, can be prevented.

To label the bottles 2, the bottles are fed in the conventional manner by means of a conveyor 8 and an inlet star wheel 9.1 to the turntable or rotor 7, so that each individual bottle is oriented with its axis in the vertical direction and the bottom of the bottle on a bottle carrier or container carrier 6, where it is secured against tipping in a suitable manner, for example by means of a spring-mounted pad 10. The labeled bottles 2 are then removed from the turntable or rotor 7 and the bottle carriers or container carriers 6 by means of an outlet star wheel 9.2 and transported via the conveyor for further processing. Downstream in the direction of rotation, indicated by the arrow A, of the turntable 7 on the bottle inlet formed by the inlet star wheel 9.1, on the machine frame of the labeling machine 1 there is a camera 11 of an image processing system 12, such that by means of said system and/or with the computer 13 located there, the dimensional tolerances and/or actual dimensions of each bottle that moves past the camera 11 are determined, and specifically in the form of variations from corresponding specified values, i.e. the dimensional tolerances of the bottle diameter, e.g. in the shoulder and body area, as well as the dimensional tolerances in the vertical direction. The specified values or the contour or of the diameter and the height for the respective type of bottle or container are stored in the computer 13 of the image processing system 12.

The differences between desired locations of the label or labels are determined by comparing the actual dimensions and/or contours and generating a signal indicative of the error between the actual dimensions and/or contours and the specific dimensions and/or contours. This error signal could be used to pick a correction signal to be transmitted to at least the bottle carrier to compensate for differences between actual dimensions and/ or contours and specific dimensions and/or contours, which would move the bottle into a proper location for placement of a label and/or multiple labels. There may be differences in the adjusted position of a bottle for each of the multiple labels, depending upon the deviation or deviations from the actual dimensions and/or contours and the specified dimensions and/or contours. Alternatively, a look-up table could be stored in the memory of the computer with numerous values relating to the placement of labels for the various actual dimensions and/or contours.

Depending on the result of the measurement and/or analysis of the individual bottle 2 by the image processing system 12, by means of a control device 14 that is actuated by the computer 13, there is a controlled rotation, adjustment of the rotational position, of each bottle carrier or container carrier 6 and thus a rotation of the respective bottle 2 around its vertical bottle axis as a function of the diameter tolerances measured, as indicated by the double arrow B, and a vertical adjustment of the respective bottle carrier or container carrier 6 in the direction of the vertical axis as a function of the determined tolerances in the height of the respective bottle 2, such that at the labeling stations or units 15 and 16 that are provided on the machine frame downstream of the camera 11 in the direction of rotation A, the respective labels 4 and/or 5 can be applied to the bottle 2 in question in the specified position and in the correct relationship to each other.

In the illustrated exemplary embodiment, for example, the rotational and/or vertical adjustment of each bottle carrier or container carrier 6 that is necessary is done twice, and specifically once before the bottle reaches the labeling station 15, and then once again before the bottle reaches the next labeling station 16 in the direction of rotation A. After the labels 4 and 5 have been transferred to a bottle 2, the conventional pressing and brushing of said labels is performed by pressing and brushing elements that are not shown in the illustrations.

On the machine frame of the labeling machine 1, upstream of the bottle outlet formed by the outlet star wheel 9.2, there is an additional camera 17, which is also a part of the computer-assisted image processing system 12 and with which an image of the labeled bottles 2 is acquired on their side that is provided with the labels 4 and 5, so that with the image signal supplied by the camera 17 and the image processing, the result of the labeling achieved can be analyzed, i.e. it can be verified, for example, whether the labels 4 and 5 are in the desired positions relative to each other and in the desired position on the respective bottle 2. The result of this analysis can also be used to optimize the orientation of bottles 2 that are being labeled for the first time, i.e. to optimize the rotational and vertical adjustment for said bottles 2 and/or to carry out a defined presetting of the bottle carrier or container carrier 6 in the direction of rotation A before the bottle reaches the camera 11.

FIG. 1B illustrates the connection between the camera 17 and the computer 13, as well as the connections between the control device 14 and the labeling stations 15 and 16, according to one possible embodiment.

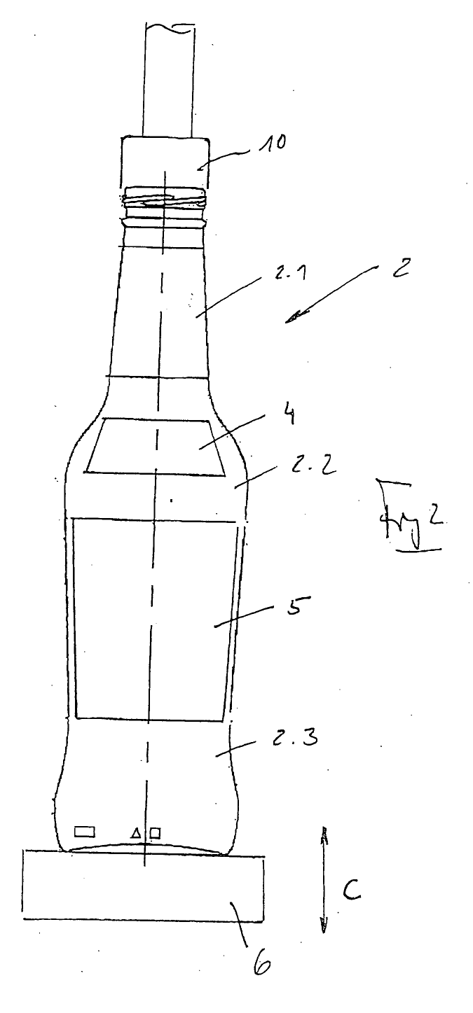

FIG. 2A is similar to FIG. 2 and shows a bottle cap 3 on the bottle 2.

In an additional configuration of this invention, there is at least one second sensor device or camera 11 (not shown) on the periphery of the turntable 7. The task of this at least one second camera 11, in connection with the image processing system 12 that is already present or with a second image processing system 12 that may also be provided, is to analyze the position of the labels that have been previously applied by the labeling units 15, 16 and, taking into consideration the dimensional tolerances of the bottle 2 that have been measured, to control the labeling process so that labels to be applied subsequently, e.g. the labels that are to be applied to the back of the bottle, are applied in the correct position. The subsequent labels must likewise be applied not only in the correct orientation with respect to the bottle 2, but also in the correct orientation with respect to the labels already applied, so that, for example, the resulting distances between the vertical side edges of the labels on the shoulder and the back of the bottle are equal.

The invention has been explained above on the basis of one exemplary embodiment. It goes without saying that numerous modifications and variations are possible without thereby going beyond the scope of the teaching of the invention. For example, it is possible not to make the adjustment in the vertical direction by raising and/or lowering the bottle carrier or container carrier 6, but by a corresponding vertical adjustment of the respective labeling unit 15 and/or 16 or of a label transfer element of the respective unit. Especially for the processing of self-adhesive labels, it is also possible, by means of the signals supplied by the computer 13, to control the labeling units so that, as a function of the measured dimensional tolerances of the bottle diameter, there is a shift in the time at which the respective self-adhesive label is dispensed or transferred to the container that is rotating around its container axis.

It is also possible to use, at least instead of the camera 11, another type of sensor device with which the actual diameter or the actual height of the respective bottle can be measured.

The invention has been explained above on the basis of the labeling machine 1 for bottles 2. It goes without saying that the invention and/or the method taught by the invention are also suitable for other containers or contoured containers of any type for liquids, bulk goods etc., for example. The invention is also of course not restricted to the labeling of containers with labels on the shoulders and body, but can also be used in the same manner for labeling containers with any type of label, e.g. including labels on the neck and/or back of the container.

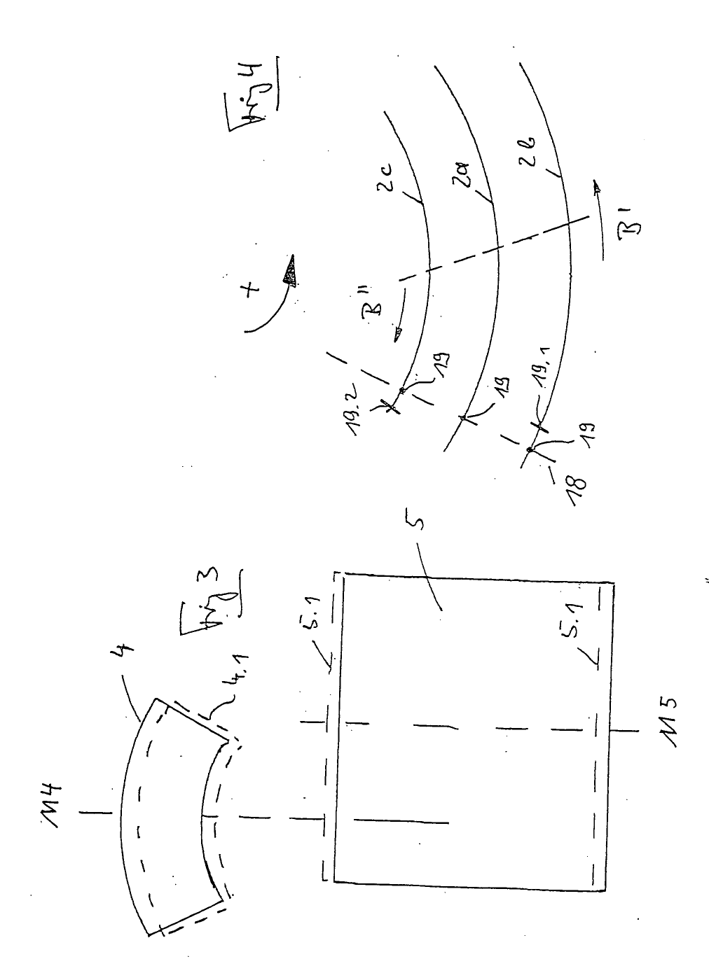

As a further explanation of the invention, FIG. 4 shows Lines 2a-2c, which represent the path of the peripheral surface of three bottles 2 with different diameters, whereby Line 2a corresponds, for example, to the specified diameter and the Lines 2b and 2c correspond to bottle diameters that differ from said specified diameter.

The transfer of the labels in the respective labeling units 15 and 16 occurs in the area identified by the line 18. 19 is the desired position of the center of the label, center axis or axis of symmetry M4 and M5, respectively, on the bottle 2.

It is apparent that in the event of dimensional variations in the circumference of the bottle (Lines 2b and 2c), without a rotational adjustment of the respective bottle 2 or of the bottle carrier or container carrier 6 and/or without an adjustment of the dispensing time, the respective label transferred on the line 18 with one side on the periphery of the bottle will not be positioned with its center axis or axis of symmetry on the point 19, but on the periphery of the bottles 2b on the point 19.1, and with the bottle diameter 2c will come to rest on the point 19.2. To achieve the correct position of the label, with the bottle diameter 2b, a rotational adjustment of the bottle 2 is necessary as indicated by the arrow B′, and with the bottle diameter 2c, a rotational adjustment of the bottle 2 as indicated by the arrow B″ in the opposite direction is necessary. Accordingly, an earlier initiation of the dispensing process is necessary in case 2c, and a delayed initiation of the dispensing process in case 2b.

According to the present application, in a method for the labeling of bottles or similar contoured containers, in which the containers are located on container carriers of a conveyor line and are moved past at least one labeling unit, and thereby at least one label is transferred to the outside surface of the respective container and then fixed in position, with at least one first sensor unit on the conveyor line, the contour of the respective container and/or the dimensions of said contour that are critical for the labeling and/or the position of any labels that have previously been applied to the container are detected to define the measured values, and that the process of applying the individual label to the container to be labeled is controlled taking into consideration the variance of the measured value from a specified value.

One feature or aspect of an embodiment is believed at the time of the filing of this patent application to possibly reside broadly in a method for labeling bottles or similar contoured containers with at least one label, in which method the containers are located on container carriers of a conveyor line and are moved past at least one labeling unit, and thereby at least one label is transferred with one side of the label on the outside surface of the respective container and then fixed in position, starting from said side of the label, on the outside surface of the container, characterized by the fact that by means of at least one first sensor unit on the conveyor line, the contour of the respective container and/or the dimensions of said contour that are critical for the labeling and/or the position of any labels that have previously been applied to the container are detected to define the measured values, and that taking into consideration the variance of the measured values from a specified value, the process of applying the respective label to the container to be labeled is controlled so that the respective label is in the desired position after it has been applied to the container.

Another feature or aspect of an embodiment is believed at the time of the filing of this patent application to possibly reside broadly in a method for labeling bottles or similar contoured containers, characterized by the fact that as a function of the respective measured value, there is a rotational adjustment of the respective container or of a container carrier that carries said container around a container axis.

Yet another feature or aspect of an embodiment is believed at the time of the filing of this patent application to possibly reside broadly in a method for labeling bottles or similar contoured containers characterized by the fact that, as a function of the measured value, the time of the transfer of the individual label to the individual container that is moving past a labeling unit and rotating around its container axis is adjusted.

Still another feature or aspect of an embodiment is believed at the time of the filing of this patent application to possibly reside broadly in a method for labeling bottles or similar contoured containers characterized by the fact that as a function of the measured value, there is a vertical adjustment of the respective container or of the container carrier relative to the labeling unit.

A further feature or aspect of an embodiment is believed at the time of the filing of this patent application to possibly reside broadly in a method for labeling bottles or similar contoured containers characterized by the fact that as a function of the measured value, there is a vertical adjustment of the labeling unit relative to the respective container or to the container carrier.

Another feature or aspect of an embodiment is believed at the time of the filing of this patent application to possibly reside broadly in a method for labeling bottles or similar contoured containers, characterized by the fact that on the respective container, at least two labels are applied in areas that are spatially separated from each other, for example a neck, shoulder, body and/or back label.

Yet another feature or aspect of an embodiment is believed at the time of the filing of this patent application to possibly reside broadly in a method for labeling bottles or similar contoured containers, characterized by the fact that the application of the at least two labels is done sequentially one after the other, and that at least after the application of a sequentially first label, the further transfer of one or more labels is controlled as a function of the measured-values signal.

Still another feature or aspect of an embodiment is believed at the time of the filing of this patent application to possibly reside broadly in a method for labeling bottles or similar contoured containers, characterized by the fact that the location and orientation of the labels on the containers is detected and/or analyzed by means of at least one second sensor unit.

A further feature or aspect of an embodiment is believed at the time of the filing of this patent application to possibly reside broadly in a method for labeling bottles or similar contoured containers, characterized by the fact that the signals supplied by the at least one second sensor unit are used for the additional control of the label transfer to the containers.

Another feature or aspect of an embodiment is believed at the time of the filing of this patent application to possibly reside broadly in a method for labeling bottles or similar contoured containers, characterized by the use of a first and/or second sensor unit with at least one opto-electrical sensor.

Yet another feature or aspect of an embodiment is believed at the time of the filing of this patent application to possibly reside broadly in a method for labeling bottles or similar contoured containers, characterized by the use of at least one camera as the first and/or second sensor unit.

A further feature or aspect of an embodiment is believed at the time of the filing of this patent application to possibly reside broadly in a method for labeling bottles or similar contoured containers, characterized by the use of an image recognition system to generate control signals for the control of the label transfer.

Another feature or aspect of an embodiment is believed at the time of the filing of this patent application to possibly reside broadly in a method for labeling bottles or similar contoured containers, characterized by the fact that for the labeling, the containers are located on a turntable or rotor that is driven in rotation around a vertical machine axis.

Yet another feature or aspect of an embodiment is believed at the time of the filing of this patent application to possibly reside broadly in a labeling machine for labeling bottles or similar contoured containers with at least one label, in which labeling machine the containers are located on container carriers of a conveyor line and are moved past at least one labeling unit, and thereby at least one label is transferred with one side of the label on the outside surface of the respective container and then fixed in position, starting from said side of the label, on the outside surface of the container, characterized by the fact that by means of a control device with at least one first sensor unit on the conveyor line, the contour of the respective container and/or the dimensions of said contour that are critical for the labeling and/or the position of any labels that have previously been applied to the container are detected to define the measured values, and that taking into consideration the variance of the measured values from a specified value, the process of applying the respective label to the container to be labeled is controlled so that the respective label is in the desired position after it has been applied to the container.

Still another feature or aspect of an embodiment is believed at the time of the filing of this patent application to possibly reside broadly in a labeling machine, characterized by the fact that the control device, as a function of the respective measured value, effects a rotational adjustment of the respective container or of a container carrier that carries the respective container or one of said containers around a container axis.

A further feature or aspect of an embodiment is believed at the time of the filing of this patent application to possibly reside broadly in a labeling machine, characterized by the fact that the control device, as a function of the measured value, effects a control of the time of the transfer of the respective label to the respective container that is moving past a labeling unit and is rotating around its container axis.

Another feature or aspect of an embodiment is believed at the time of the filing of this patent application to possibly reside broadly in a labeling machine, characterized by the fact that the control device, as a function of the measured value, effects a vertical adjustment of the individual container and/or of the container carrier relative to the labeling unit.

Yet another feature or aspect of an embodiment is believed at the time of the filing of this patent application to possibly reside broadly in a labeling machine, characterized by the fact that the control device, as a function of the measured value, effects a vertical adjustment of the labeling unit relative to the respective container and/or to the container carrier.

Still another feature or aspect of an embodiment is believed at the time of the filing of this patent application to possibly reside broadly in a labeling machine, characterized by at least one second sensor unit on the conveyor line to detect the location and orientation of the labels on the containers.

A further feature or aspect of an embodiment is believed at the time of the filing of this patent application to possibly reside broadly in a labeling machine, characterized by the fact that the control device uses the signals supplied by the at least one second sensor unit for the additional control of the transfer of the labels to the container.

Another feature or aspect of an embodiment is believed at the time of the filing of this patent application to possibly reside broadly in a labeling machine, characterized by the fact that the first and/or second sensor unit has at least one opto-electrical sensor.

Yet another feature or aspect of an embodiment is believed at the time of the filing of this patent application to possibly reside broadly in a labeling machine, characterized by at least one camera as the first and/or second sensor unit.

Still another feature or aspect of an embodiment is believed at the time of the filing of this patent application to possibly reside broadly in a labeling machine, characterized by an image recognition system for the generation of control signals for the control of the label transfer.

A further feature or aspect of an embodiment is believed at the time of the filing of this patent application to possibly reside broadly in a labeling machine, characterized by the fact that the conveyor line is a turntable or rotor that is driven in rotation around a vertical machine axis.

Another feature or aspect of an embodiment is believed at the time of the filing of this patent application to possibly reside broadly in a beverage bottle labeling arrangement configured to label beverage bottles in a beverage bottling plant, said beverage bottle labeling arrangement comprising: a labeling machine being configured to label bottles; an input arrangement being configured to transfer bottles to be labeled into said labeling machine; an output arrangement being configured to transfer labeled bottles out of said labeling machine; and said labeling machine comprising: a base support structure comprising a coupling structure; a rotor structure being mounted on said base support structure and being configured to be rotated about a vertical axis by a drive arrangement; a plurality of support tables, each being mounted on the periphery of said rotor structure and being configured to be rotated about a vertical axis by a drive arrangement; each of said support tables being configured to support and rotate a bottle disposed thereon; a sensor unit being configured and disposed to sense a contour and/or dimensions of a bottle to be labeled; a computer control device being configured and disposed to determine the deviation of the contour and/or dimensions of a bottle from at least one stored nominal dimension of each bottle corresponding to the bottle being sent; said computer control device being configured and disposed to send a signal via a connection to adjust said at least one bottle carrier to compensate for the sensed position upon sensing a deviation of the contour and/or dimensions of a bottle; said at least one beverage bottle labeling station being configured and disposed to apply at least one label on a bottle to compensate for the deviation of the contour and/or dimensions of a bottle, upon said computer control device sensing a deviation of the contour and/or dimensions of a bottle.

Yet another feature or aspect of an embodiment is believed at the time of the filing of this patent application to possibly reside broadly in a method of labeling bottles in a labeling machine in a beverage bottling plant, said method comprising the steps of: a) sensing at least one dimension of a bottle to be labeled; b) determining at least one deviation of the at least one dimension of a bottle being sensed in Step a) from at least one stored dimension corresponding to the bottle being sensed, upon there being a deviation; c) adjusting the labeling machine to compensate for any determined deviation from Step b), upon there being a deviation; and d) applying at least one label to the bottle to be labeled.

Still another feature or aspect of an embodiment is believed at the time of the filing of this patent application to possibly reside broadly in a beverage bottle labeling arrangement configured to label beverage bottles in a beverage bottling plant, said beverage bottle labeling arrangement comprising: a sensor being configured to sense at least one dimension and/or at least one contour of a bottle to be labeled; a controller being configured to determine at least one deviation of the at least one dimension and/or at least one contour of a bottle being sensed from at least one stored dimension corresponding to the bottle being sensed, upon there being a deviation; an apparatus being configured to adjust the labeling machine to compensate for any determined deviation, upon there being a deviation; and a labeling station being configured to apply at least one label to the bottle to be labeled.

The components disclosed in the various publications, disclosed or incorporated by reference herein, may possibly be used in possible embodiments of the present invention, as well as equivalents thereof.

The purpose of the statements about the technical field is generally to enable the Patent and Trademark Office and the public to determine quickly, from a cursory inspection, the nature of this patent application. The description of the technical field is believed, at the time of the filing of this patent application, to adequately describe the technical field of this patent application. However, the description of the technical field may not be completely applicable to the claims as originally filed in this patent application, as amended during prosecution of this patent application, and as ultimately allowed in any patent issuing from this patent application. Therefore, any statements made relating to the technical field are not intended to limit the claims in any manner and should not be interpreted as limiting the claims in any manner.

Some examples of bottling systems, which may be used or adapted for use in at least one possible embodiment of the present may be found in the following U.S. patents assigned to the Assignee herein, namely: U.S. Pat. No. 4,911,285; U.S. Pat. No. 4,944,830; U.S. Pat. No. 4,950,350; U.S. Pat. No. 4,976,803; U.S. Pat. No. 4,981,547; U.S. Pat. No. 5,004,518; U.S. Pat. No. 5,017,261; U.S. Pat. No. 5,062,917; U.S. Pat. No. 5,062,918; U.S. Pat. No. 5,075,123; U.S. Pat. No. 5,078,826; U.S. Pat. No. 5,087,317; U.S. Pat. No. 5,110,402; U.S. Pat. No. 5,129,984; U.S. Pat. No. 5,167,755; U.S. Pat. No. 5,174,851; U.S. Pat. No. 5,185,053; U.S. Pat. No. 5,217,538; U.S. Pat. No. 5,227,005; U.S. Pat. No. 5,413,153; U.S. Pat. No. 5,558,138; U.S. Pat. No. 5,634,500; U.S. Pat. No. 5,713,403; U.S. Pat. No. 6,276,113; U.S. Pat. No. 6,213,169; U.S. Pat. No. 6,189,578; U.S. Pat. No. 6,192,946; U.S. Pat. No. 6,374,575; U.S. Pat. No. 6,365,054; U.S. Pat. No. 6,619,016; U.S. Pat. No. 6,474,368; U.S. Pat. No. 6,494,238; U.S. Pat. No. 6,470,922; and No. 6,463,964.

The appended drawings in their entirety, including all dimensions, proportions and/or shapes in at least one embodiment of the invention, are accurate and are hereby included by reference into this specification.

The background information is believed, at the time of the filing of this patent application, to adequately provide background information for this patent application. However, the background information may not be completely applicable to the claims as originally filed in this patent application, as amended during prosecution of this patent application, and as ultimately allowed in any patent issuing from this patent application. Therefore, any statements made relating to the background information are not intended to limit the claims in any manner and should not be interpreted as limiting the claims in any manner.

Some examples of cameras or the like optical monitoring apparatus that may possibly be utilized or possibly adapted for use in at least one possible embodiment of the present application may possibly be found in the following U.S. patents: U.S. Pat. No. 5,233,186 issued to Ringlien on Aug. 3, 1993; U.S. Pat. No. 5,243,400 issued to Ringlien on Sep. 7, 1993; U.S. Pat. No. 5,369,713 issued to Schwartz et al. on Nov. 29, 1994; U.S. Pat. No. 5,442,446 issued to Gerber et al. on Aug. 15, 1995; U.S. Pat. No. 5,661,295 issued to Buchmann et al. on Aug. 26, 1997; and U.S. Pat. No. 5,898,169 issued to Nodbryhn on Apr. 27, 1999.

All, or substantially all, of the components and methods of the various embodiments may be used with at least one embodiment or all of the embodiments, if more than one embodiment is described herein.

The purpose of the statements about the object or objects is generally to enable the Patent and Trademark Office and the public to determine quickly, from a cursory inspection, the nature of this patent application. The description of the object or objects is believed, at the time of the filing of this patent application, to adequately describe the object or objects of this patent application. However, the description of the object or objects may not be completely applicable to the claims as originally filed in this patent application, as amended during prosecution of this patent application, and as ultimately allowed in any patent issuing from this patent application. Therefore, any statements made relating to the object or objects are not intended to limit the claims in any manner and should not be interpreted as limiting the claims in any manner.

Some examples of rotation sensors that may possibly be utilized or possibly adapted for use in at least one possible embodiment of the present application may possibly be found in the following U.S. patents: U.S. Pat. No. 6,246,232 issued to Okamura on Jun. 12, 2001; U.S. Pat. No. 6,448,761 issued to Stumpe on Sep. 10, 2002; U.S. Pat. No. 6,474,162 to Voss et al. on Nov. 5, 2002; U.S. Pat. No. 6,498,481 issued to Apel on Dec. 24, 2002; U.S. Pat. No. 6,532,831 issued to Jin et al. on Mar. 18, 2003; and U.S. Pat. No. 6,672,175 issued to Jin et al. on Jan. 6, 2004.

All of the patents, patent applications and publications recited herein, and in the Declaration attached hereto, are hereby incorporated by reference as if set forth in their entirety herein.

Some examples of position sensors or position sensor systems that may be used or adapted for use in at least one possible embodiment of the present invention may be found in the following U.S. patents: U.S. Pat. No. 5,794,355, issued to inventor Nickum on Aug. 18, 1998; U.S. Pat. No. 5,520,290, issued to inventors Kumar et al. on May 28, 1996; U.S. Pat. No. 5,074,053, issued to inventor West on Dec. 24, 1991; and U.S. Pat. No. 4,087,012, issued to inventor Fogg on May 2, 1978.

The summary is believed, at the time of the filing of this patent application, to adequately summarize this patent application. However, portions or all of the information contained in the summary may not be completely applicable to the claims as originally filed in this patent application, as amended during prosecution of this patent application, and as ultimately allowed in any patent issuing from this patent application. Therefore, any statements made relating to the summary are not intended to limit the claims in any manner and should not be interpreted as limiting the claims in any manner.

Some examples of laser printing arrangements that may possibly be utilized or possibly adapted for use in at least one possible embodiment of the present application may possibly be found in the following U.S. patents: U.S. Pat. No. 4,847,643 issued to Ohmori on Jul. 11, 1989; U.S. Pat. No. 5,294,945 issued to Omura et al. on Mar. 15, 1994; U.S. Pat. No. 5,528,280 issued to Endo et al. on Jun. 18, 1996; U.S. Pat. No. 6,210,778 issued to Poirier et al. on Apr. 3, 2001; U.S. Pat. No. 6,433,810 issued to Katayama et al. on Aug. 13, 2002; and U.S. Pat. No. 6,655,275 issued to Mugrauer on Dec. 2, 2003.

It will be understood that the examples of patents, published patent applications, and other documents which are included in this application and which are referred to in paragraphs which state “Some examples of . . . which may possibly be used in at least one possible embodiment of the present application . . . ” may possibly not be used or useable in any one or more embodiments of the application.

The sentence immediately above relates to patents, published patent applications and other documents either incorporated by reference or not incorporated by reference.

Some examples of laser marking that may possibly be utilized or possibly adapted for use in at least one possible embodiment of the present application may possibly be found in the following U.S. patents: U.S. Pat. No. 6,429,889 issued to Murokh on Aug. 6, 2002; U.S. Pat. No. 6,483,073 issued to Tenderly on Nov. 19, 2002; U.S. Pat. No. 6,489,985 issued to Brodsky et al. on Dec. 3, 2002; U.S. Pat. No. 6,613,161 issued to Zheng et al. on Sep. 2, 2003; U.S. Pat. No. 6,627,299 issued to Feng et al. on Sep. 30, 2003; and U.S. Pat. No. 6,683,637 issued to Corbett on Jan. 27, 2004.

The corresponding foreign patent publication applications, namely, Federal Republic of Germany Patent Application No. 10 2004 040 634.0, filed on Aug. 21, 2004, having inventor Frank Putzer, and DE-OS 10 2004 040 634.0 and DE-PS 10 2004 040 634.0, are hereby incorporated by reference as if set forth in their entirety herein for the purpose of correcting and explaining any possible misinterpretations of the English translation thereof. In addition, the published equivalents of the above corresponding foreign and international patent publication applications, and other equivalents or corresponding applications, if any, in corresponding cases in the Federal Republic of Germany and elsewhere, and the references and documents cited in any of the documents cited herein, such as the patents, patent applications and publications, are hereby incorporated by reference as if set forth in their entirety herein.

Some examples of ink jet printing apparatus and methods that may possibly be utilized or possibly adapted for use in at least one possible embodiment of the present application may possibly be found in the following U.S. patents: U.S. Pat. No. 6,582,047 issued to Koitabashi et al. on Jun. 24, 2003; U.S. Pat. No. 6,623,093 issued to Takahashi et al. on Sep. 23, 2003; U.S. Pat. No. 6,625,351 issued to Cox et al. on Sep. 23, 2003; U.S. Pat. No. 6,652,055 issued to Oikawa on Nov. 25, 2003; U.S. Pat. No. 6,669,767 issued to Blease et al. on Dec. 30, 2003; and U.S. Pat. No. 6,688,739 issued to Murray on Feb. 10, 2004.

All of the references and documents, cited in any of the documents cited herein, are hereby incorporated by reference as if set forth in their entirety herein. All of the documents cited herein, referred to in the immediately preceding sentence, include all of the patents, patent applications and publications cited anywhere in the present application.

Some examples of lifting devices that may possibly be utilized or possibly adapted for use in at least one possible embodiment of the present application may possibly be found in the following patent publications: U.S. Pat. No. 2,535,272 issued to Detrez on Dec. 26, 1950; U.S. Pat. No. 2,642,214 issued to Lippold on Jun. 16, 1953; German Utility Model No. DE-GM 1,923,261 issued on Sep. 9, 1965; German Laid Open Patent Application No. DE-OS 1,532,586 published on Oct. 2, 1969; British Patent No. 1,188,888 issued Apr. 22, 1970; German Laid Open Patent Application No. DE-OS 26 52 910 published on May 24, 1978; German Patent No. DE-PS 26 52 918 issued on Oct. 26, 1978; German Utility Model No. DE-GM 83 04 995 issued on Dec. 22, 1983; German Patent No. DE-PS 26 30 100 issued on Dec. 3, 1981; and German Laid Open Patent Application No. DE-OS 195 45 080 published on Jun. 5, 1997.

The description of the embodiment or embodiments is believed, at the time of the filing of this patent application, to adequately describe the embodiment or embodiments of this patent application. However, portions of the description of the embodiment or embodiments may not be completely applicable to the claims as originally filed in this patent application, as amended during prosecution of this patent application, and as ultimately allowed in any patent issuing from this patent application. Therefore, any statements made relating to the embodiment or embodiments are not intended to limit the claims in any manner and should not be interpreted as limiting the claims in any manner.

Some examples of computer systems that may possibly be utilized or possibly adapted for use in at least one possible embodiment of the present application may possibly be found in the following U.S. patents: U.S. Pat. No. 5,416,480 issued to Roach et al. on May 16, 1995; U.S. Pat. No. 5,479,355 issued to Hyduke on Dec. 26, 1995; U.S. Pat. No. 5,481,730 issued to Brown et al. on Jan. 2, 1996; U.S. Pat. No. 5,805,094 issued to Roach et al. on Sep. 8, 1998; U.S. Pat. No. 5,881,227 issued to Atkinson et al. on Mar. 9, 1999; and U.S. Pat. No. 6,072,462 issued to Moshovich on Jun. 6, 2000.

The details in the patents, patent applications and publications may be considered to be incorporable, at applicant's option, into the claims during prosecution as further limitations in the claims to patentably distinguish any amended claims from any applied prior art.

Some examples of adhesive applicators that may possibly be utilized or possibly adapted for use in at least one possible embodiment of the present application may possibly be found in the following U.S. patents: U.S. Pat. No. 5,700,322 issued to Fort on Dec. 23, 1997 U.S. Pat. No. 5,862,986 issued to Bolyard, Jr. et al. on Jan. 26, 1999; U.S. Pat. No. 6,076,711 issued to McGuffey on Jun. 20, 2000; U.S. Pat. No. 6,168,049 issued to Bollard, Jr. on Jan. 2, 2001; U.S. Pat. No. 6,499,631 issued to Zook on Dec. 31, 2002; and U.S. Pat. No. 6,592,281 issued to Clark et al. on Jul. 15, 2003.

The purpose of the title of this patent application is generally to enable the Patent and Trademark Office and the public to determine quickly, from a cursory inspection, the nature of this patent application. The title is believed, at the time of the filing of this patent application, to adequately reflect the general nature of this patent application. However, the title may not be completely applicable to the technical field, the object or objects, the summary, the description of the embodiment or embodiments, and the claims as originally filed in this patent application, as amended during prosecution of this patent application, and as ultimately allowed in any patent issuing from this patent application. Therefore, the title is not intended to limit the claims in any manner and should not be interpreted as limiting the claims in any manner.

Some examples of labeling machines which may possibly be utilized in at least one possible embodiment may possibly be found in the following U.S patents: U.S. Pat. No. 6,634,400, entitled “Labeling machine;” U.S. Pat. No. 6,561,246, entitled “Labeling machine capable of precise attachment of a label to different sizes of containers;” U.S. Pat. No. 6,550,512, entitled “Labeling machine capable of preventing erroneous attachment of labels on containers;” U.S. Pat. No. 6,543,514, entitled “In-line continuous feed sleeve labeling machine and method;” U.S. Pat. No. 6,378,587, entitled “Cylindrical container labeling machine;” U.S. Pat. No. 6,328,086, entitled “Labeling machine;” U.S. Pat. No. 6,315,021, entitled “Labeling machine;” U.S. Pat. No. 6,263,940, entitled “In-line continuous feed sleeve labeling machine and method;” U.S. Pat. No. 6,199,614, entitled “High speed labeling machine having a constant tension driving system;” U.S. Pat. No. 6,167,935, entitled “Labeling machine; U.S. Pat. No. 6,066,223, entitled “Labeling machine and method; U.S. Pat. No. 6,050,319, entitled “Non-round container labeling machine and method;” and U.S. Pat. No. 6,045,616, entitled “Adhesive station and labeling machine.”

The abstract of the disclosure is submitted herewith as required by 37 C.F.R. §1.72(b). As stated in 37 C.F.R. §1.72(b):
A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims.
   Therefore, any statements made relating to the abstract are not intended to limit the claims in any manner and should not be interpreted as limiting the claims in any manner.

Some examples of starwheels which may possibly be utilized or adapted for use in at least one possible embodiment may possibly be found in the following U.S. patents: U.S. Pat. No. 5,613,593, entitled “Container handling starwheel;” U.S. Pat. No. 5,029,695, entitled “Improved starwheel;” U.S. Pat. No. 4,124,112, entitled “Odd-shaped container indexing starwheel;” and U.S. Pat. No. 4,084,686, entitled “Starwheel control in a system for conveying containers.”

The embodiments of the invention described herein above in the context of the preferred embodiments are not to be taken as limiting the embodiments of the invention to all of the provided details thereof, since modifications and variations thereof may be made without departing from the spirit and scope of the embodiments of the invention.

### AT LEAST PARTIAL LIST OF TERMS

1 Labeling machine
2 Bottle
2.1 Neck area
2.2 Shoulder area
2.3 Body area
3 Cap
4 Shoulder label
5 Body label
6 Bottle carrier or container carrier
7 Rotor or turntable
8 Conveyor
9.1 Inlet star wheel
9.2 Outlet star wheel
10 Pad
11 Camera
12 Image processing system
13 Computer of the image processing system
14 Control device
15, 16 Labeling unit
17 Additional camera
18 Label transfer position
19, 19.1, 19.2 Position of the center of the label
Arrow A Direction of rotation of the rotor or turntable 7
Arrow B Rotational adjustment of the bottle carrier or container carrier 6
Arrow C Vertical adjustment of the bottle carrier or container carrier 6

What is claimed is:

1. A beverage bottle labeling arrangement configured to label beverage bottles in a beverage bottling plant, said beverage bottle labeling arrangement comprising:
a labeling machine being configured to label bottles;
an input arrangement being configured to transfer bottles to be labeled into said labeling machine;
an output arrangement being configured to transfer labeled bottles out of said labeling machine; and
said labeling machine comprising:
a base support structure comprising a coupling structure;
a rotor structure being mounted on said base support structure and being configured to be rotated about a vertical axis by a drive arrangement;
a plurality of support tables, each being mounted on the periphery of said rotor structure and being configured to be rotated about a vertical axis by a drive arrangement;
each of said support tables being configured to support and rotate a bottle disposed thereon;
a sensor unit being configured and disposed to sense a contour and/or dimensions of a bottle to be labeled;
a computer control device being configured and disposed to determine the deviation of the contour and/or dimensions of a bottle from at least one stored nominal dimension of each bottle corresponding to the bottle being sent;
said computer control device being configured and disposed to send a signal via a connection to adjust said at least one bottle carrier to compensate for the sensed position upon sensing a deviation of the contour and/or dimensions of a bottle;
said at least one beverage bottle labeling station being configured and disposed to apply at least one label on a bottle to compensate for the deviation of the contour and/or dimensions of a bottle, upon said computer control device sensing a deviation of the contour and/or dimensions of a bottle.

2. A method of labeling bottles in a labeling machine in a beverage bottling plant, said method comprising the steps of:
a) sensing at least one dimension of a bottle to be labeled;
b) determining at least one deviation, upon there being a deviation, of the at least one dimension of a bottle being sensed in Step a) from at least one stored dimension corresponding to the bottle being sensed;
c) adjusting the labeling machine to compensate for the at least one determined deviation from Step b), upon there being a deviation; and
d) applying at least one label to the bottle to be labeled.

4. The method according to claim 3, wherein as a function of the respective measured value, there is a rotational adjustment of the respective container or of a container carrier that carries said container around a container axis.

5. The method according to claim 4, wherein, as a function of the measured value, the time of the transfer of the individual label to the individual container that is moving past a labeling unit and rotating around its container axis is adjusted.

6. The method according to claim 5, wherein as a function of the measured value, there is a vertical adjustment of the respective container or of the container carrier relative to the labeling unit.

7. The method according to claim 6, wherein as a function of the measured value, there is a vertical adjustment of the labeling unit relative to the respective container or to the container carrier.

8. The method according to claim 7, wherein on the respective container, at least two labels are applied in areas that are spatially separated from each other, for example a neck, shoulder, body and/or back label.

9. The method according to claim 8, wherein the application of the at least two labels is done sequentially one after the other, and that at least after the application of a sequentially first label, the further transfer of one or more labels is controlled as a function of the measured-values signal.

10. The method according to claim 9, wherein the location and orientation of the labels on the containers is detected and/or analyzed by means of at least one second sensor unit.

11. The method according to claim 3, wherein the signals supplied by the at least one second sensor unit are used for the additional control of the label transfer to the containers.

12. The method according to claim 3, comprising the use of a first and/or second sensor unit with at least one opto-electrical sensor.

13. The method according to claim 12, wherein:
at least one camera is used as the first and/or second sensor unit;
an image recognition system is used to generate control signals for the control of the label transfer; and
for the labeling, the containers are located on a turntable or rotor that is driven in rotation around a vertical machine axis.

14. A beverage bottle labeling arrangement configured to label beverage bottles in a beverage bottling plant, said beverage bottle labeling arrangement comprising:
a sensor being configured to sense at least one dimension and/or at least one contour of a bottle to be labeled;
a controller being configured to determine at least one deviation, upon there being a deviation, of the at least one dimension and/or at least one contour of a bottle being sensed from at least one stored dimension corresponding to the bottle being sensed;
an apparatus being configured to adjust the labeling machine to compensate for the at least one determined deviation; and
a labeling station being configured to apply at least one label to the bottle to be labeled.

15. The labeling arrangement according to claim 14, wherein the controller, as a function of the respective measured value, effects a rotational adjustment of the respective container or of a container carrier that carries the respective container or one of said containers around a container axis.

16. The labeling arrangement according to claim 15, wherein the controller, as a function of the measured value, effects a control of the time of the transfer of the respective label to the respective container that is moving past a labeling unit and is rotating around its container axis.

17. The labeling arrangement according to claim 16, wherein the controller, as a function of the measured value, effects a vertical adjustment of the individual container and/or of the container carrier relative to the labeling unit.

18. The labeling arrangement according to claim 17, wherein the control device, as a function of the measured value, effects a vertical adjustment of the labeling unit relative to the respective container and/or to the container carrier.

19. The labeling arrangement according to claim 18, wherein:
at least one second sensor unit is on the conveyor line to detect the location and orientation of the labels on the containers;
the control device uses the signals supplied by the at least one second sensor unit for the additional control of the transfer of the labels to the container; and
the first and/or second sensor unit has at least one opto-electrical sensor.

20. The labeling arrangement according to claim 17, wherein:
at least one camera is used as the first and/or second sensor unit;
an image recognition system is used for the generation of control signals for the control of the label transfer;
the conveyor line is a turntable or rotor that is driven in rotation around a vertical machine axis.
